(19) United States
(12) Patent Application Publication
(10) Pub. No.: US 2015/0316088 A1
(43) Pub. Date: Nov. 5, 2015

(54) SCREWCON

(71) Applicants: Andrew Harold PEARCE, Jupiter, FL (US); Paulette Sue MANNINO, Jupiter, FL (US)

(72) Inventors: Andrew Harold PEARCE, Jupiter, FL (US); Paulette Sue MANNINO, Jupiter, FL (US)

(21) Appl. No.: 14/677,961

(22) Filed: Apr. 2, 2015

Related U.S. Application Data
(63) Continuation-in-part of application No. 14/269,086, filed on May 3, 2014, now abandoned.

(51) Int. Cl. F16B 25/10

(52) U.S. Cl. CPC F16B 25/103

(57) ABSTRACT

A self-drilling and self-tapping anchoring screw for attachment to a concrete substrate formed from hardened steel or the like suitable material, and having a threaded proximal portion including a radially enlarged head and a coaxial distal portion, forming a concrete drill bit having a fluted shank and a concrete drill bit tip, said threaded proximal portion including a double lead, spaced thread configuration including a first thread helix of a given height and a second thread helix of a smaller height than said first thread helix; said first and second thread helix defining a space therebetween which serves as a reservoir to receive dust that is produced during the tapping operation and wherein said fluted shank functions to eject any particulates created during a drilling operation thereby enabling the threaded proximal portion to form an effective threaded connection with the concrete substrate during said tapping operation.

### CROSS REFERENCE TO RELATED APPLICATIONS

This application is a continuation-in-part of co-pending U.S. application Ser. No. 14/269,086 filed on May 3, 2014 the contents of which is hereby incorporated by reference in its entirety.

### FIELD OF THE INVENTION

This invention relates to concrete anchoring screws made of hardened steel combined with a concrete drill tip designed to fasten items to concrete.

### BACKGROUND OF THE INVENTION

The present invention relates generally to a self-drilling, self-tapping screw for drilling into a variety of base materials that include concrete, brick, mortar joints and block, and concrete masonry units (CMU)—also called concrete brick, concrete block, cement block, besser block, breeze block and cinder block.

Concrete is a hard and friable substance which is generally difficult to penetrate and engage with a threaded fastener. Due to its physical properties, attachment of screws to concrete of conventionally require that that a clearance hole be provided before any fastener may be affixed to the concrete. Conventionally, when fastening an item to concrete block one typically first uses a carbide tipped drill to provide a clearance hole before a self-tapping fastener can be installed. After the hole is drilled with a drill bit in a hammer drill, a screw gun is used to install the screw. In some applications, a lead or plastic insert may be placed in the clearance hole before the screw is installed. While this process works well, it may be characterized by relatively high labor and material costs because the process involves several steps, multiple tools and frequently the handling and installation of multi-piece fasteners.

### DESCRIPTION OF THE PRIOR ART

U.S. Pat. No. 6,250,866, the contents of which is incorporated herein by reference in its entirety, is directed toward a self-drilling, self-tapping screw for light concrete blocks or other such concrete substrates of limited thickness. The patent describes a one-piece drill/fastener combination constructed of a unitary piece of steel which mounts a carbide drill tip. The fastener portion is composed of a head and a specially configured shank extending from the underside of the head to the drill tip. The shank has a threaded portion adjacent the head and an unthreaded portion extending from the threaded portion to a distal slot for holding a carbide drill tip. The head is adapted for rotational engagement with a driving tool and includes a radially enlarged flange for bearing against the material to be fastened. The threaded portion of the shank includes dual diameter threads that are capable of forming and mating with grooves in the clearance hole. The distal end of the unthreaded portion of the shank provides a location for mounting the carbide drill tip in an axially spaced relationship to the threaded portion of the shank. The length of the unthreaded portion of the shank is preferably at least equal to the thickness of the concrete substrate.

More particularly, the length of the unthreaded portion of the shank is selected such that the drill tip can fully penetrate the concrete substrate prior to the threaded portion engaging the clearance hole. This relationship is described as being significant because the axial progress of the self-drilling tip through the concrete will vary depending on the hardness of the material being drilled, the amount of pressure axially exerted on the drill tip and the rotational speed of the drill tip. In contrast, the axial progress of the threaded portion of the shank through the concrete substrate is determined by the slope of the threads and the rotational speed of the shank.

The '866 patent states that if the hole is not completely drilled through the concrete substrate prior to threaded engagement with the clearance hole, the threads will attempt to force the drilling tip through the concrete substrate at an axial rate faster than the drill tip is capable of penetrating the concrete substrate. The axial and rotational forces presented by such a mismatch will lead to mechanical failure of the fastener or failure of threaded engagement with the concrete substrate (stripping of the threads).

U.S. Pat. No. 5,190,426, the contents of which is incorporated herein by reference in its entirety, relates generally to an improved fastener useful for attaching objects to a structure composed of a solid, hard material, such as concrete and the like. More specifically, the invention relates to an improved construction of a concrete or masonry fastener. The fastener of the '426 patent is designed to be rotatably driven into a bore defined in a wall of concrete or masonry to secure a fitting to the wall. As the fastener enters the bore, the multi-diameter relationship of the threads defining the first stage stabilizes and centers the fastener relative to the bore and insures that the fastener will be received co-axially into the bore. As the fastener turns further into the bore, the '426 patent recognizes that when particulate is cut by the threads of the first stage it begins to collect between the threads. If this were permitted to continue, the patent teaches that particulate could jam between the threads and interfere with complete insertion into the bore. In order to avoid this problem, the '426 patent requires that the second stage is designed with a relatively greater pitch of the thread in the second stage, which serves as a reservoir or collecting area for the particulate being generated as insertion continues, so as not to hamper insertion of the fastener.

U.S. Pat. No. 4,034,641, the contents of which is incorporated herein by reference in its entirety, is further directed toward a self-drilling and tapping anchor for use in masonry structures which includes an upper, tapping thread portion and a lower, stabilizing and dust receiving shank portion intermediate the tapping thread and a drill tip. The lower shank has a cross-sectional configuration which defines a maximum and minimum radial dimension with the maximum dimension being greater than or equal to the hole being drilled to axially stabilize and support the fastener as it is drilled into the masonry. The minimum radial dimension and the wall of the hole forming a reservoir into which masonry dust is received during drilling.

The fastener of the '641 patent includes a threaded shank having a drill tip at one end and a driving head at the other end and a lower shank region intermediate the threaded shank and the drill tip. The lower shank region is taught to have a preferable length equal to or greater than the thickness of the masonry wall which is to be drilled and should be of a cross-sectional configuration including a maximum and minimum radial dimension. The minimum radial dimension provides, in conjunction with the wall of the hole being drilled, a reservoir into which concrete or masonry dust can freely flow. The maximum dimension of the lower shank region is taught as providing continuous support against the walls of the hole being drilled, thus insuring vertical or axial stability for the anchor as it proceeds through the wall. The '641 patent further teaches that a difference in tapping speed and drilling speed results in either inadequate drilling or a stripping of threads to be formed in the wall of the hole. Furthermore, the '641 patent states that the dust and debris created during the drilling in concrete must be properly exhausted and removed from the drill tip or the drill will be subjected to excessive heat causing a reduction in drilling efficiency. In addition to the heat, the compacted and trapped dust and debris creates a serious increase in friction and subsequent binding of the screw anchor in the hole, which could, and in most cases does, result in a shearing of the head from the shank.

The prior art devices fail to teach or suggest a self-drilling and self-tapping concrete fastener that enables successful drilling into concrete materials of a thickness equal to or greater that the overall length of the fastener, while insuring drilling of a stable, properly configured guide hole, while enabling the secure threading of the fastener into the concrete material, while providing a means for simultaneous expulsion of dust and particulates that would otherwise degrade the integrity of the union between the concrete material and the fastener, and further protect the fastener from excessive shear and possible failure.

### SUMMARY OF THE INVENTION

The invention is directed toward a concrete anchoring screw made of hardened steel combined with a concrete drill bit tip designed to fasten items to concrete. This new design eliminates the need to drill the hole first with a drill prior to drilling in the actual screw allowing the screw to be installed in one step versus two steps which is required now, saving time. This screw is entirely different than what exists on the market now due to its unique all in one design. The concrete anchoring screw, SCREWCON, will be available in several sizes.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 illustrates a prior art self-drilling and self-tapping concrete anchoring screw in accordance with U.S. Pat. No. 6,250,866 having a screw head, a screw body and a concrete drill bit tip;

FIG. 2 illustrates a prior art self-drilling and self-tapping concrete anchoring screw in accordance with U.S. Pat. No. 5,190,426 having a screw head, a screw body and a concrete drill bit tip;

FIG. 3 illustrates a prior art self-drilling and self-tapping concrete anchoring screw in accordance with U.S. Pat. No. 4,034,641 having a screw head, a screw body and a concrete drill bit tip;

FIG. 4 illustrates a perspective view of an embodiment of the present invention including a self-drilling and self-tapping concrete anchoring screw having a distal portion including a concrete drill bit having a fluted shank between the drill bit tip and the beginning of the threaded section of the proximal portion of the concrete anchoring screw;

FIG. 5 illustrates the concrete anchoring screw of FIG. 4, illustrating the dimensions of an embodiment;

FIG. 6 illustrates a perspective view of an embodiment of the present invention including a self-drilling and self-tapping concrete anchoring screw having a distal portion including a concrete drill bit having a fluted shank between the drill bit tip and the beginning of the threaded section of the proximal portion of the concrete anchoring screw and a proximal threaded section including relief slots for assisting in the ejection of debris;

FIG. 7 is a cross-sectional view of the embodiment of FIG. 6 taken through the relief slots.

### DETAILED DESCRIPTION OF THE INVENTION

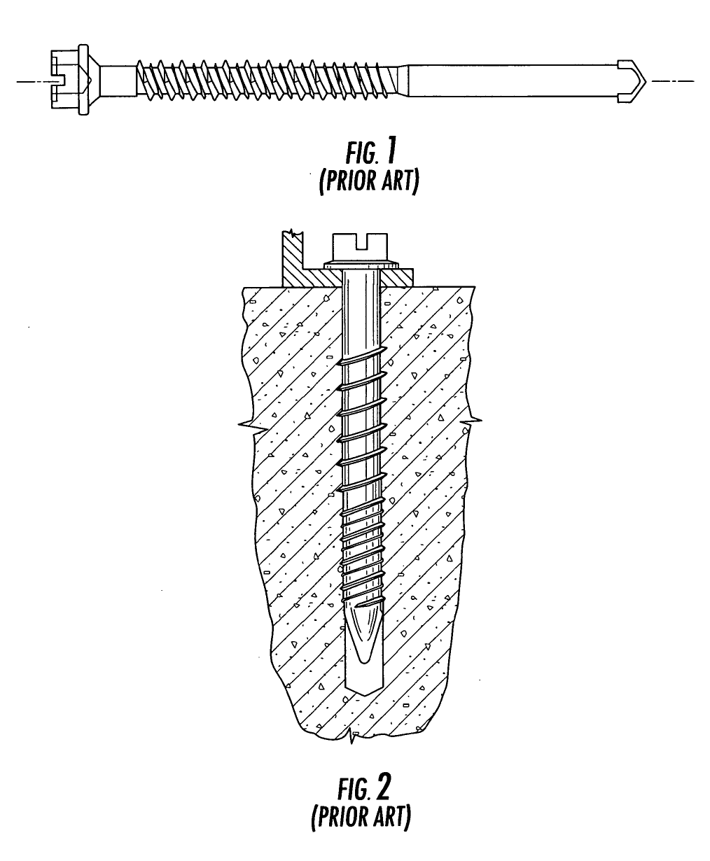

With reference to FIG. 1, this figure illustrates the prior art fastener of U.S. Pat. No. 6,250,866. In particular, FIG. 1 illustrates the self-drilling, self-tapping screw having a head, a shank and drill tip. The shank integrally extends from the head and defines the axis of the screw. A first portion of the shank, closest the head, is unthreaded. A second portion of the shank is provided with a dual diameter, self tapping spiral thread. A third portion of the shank is unthreaded and extends from the threaded second portion to a distal tip where a slot is formed to accommodate the insertion of a carbide drill tip.

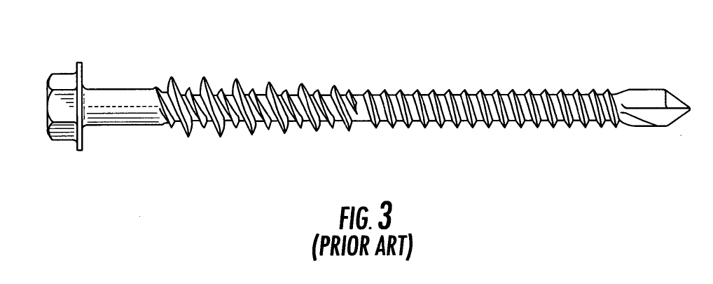

Referring to FIG. 2, this figure illustrates the prior art fastener of U.S. Pat. No. 5,190,426. As shown in FIG. 1, the fastener of the invention includes a generally cylindrical shank having a driving head on one end and an entering point on the other end. The head includes driving surfaces for driving engagement by a wrench and a transverse slot for receiving a screw driver. The point of the fastener may be configured as a so-called “X-point” of known construction. The shank of the fastener includes a smooth unthreaded portion extending from adjacent the head some distance along the shank. The fastener further includes a threaded portion consisting of a first stage and a second stage disposed successively along the shank. A first thread is disposed on the shank continuously to the unthreaded shank portion. The fastener includes a second thread disposed along the shank which terminates near the midpoint of the first thread so as to define the first stage of the fastener. The second thread is disposed midway between the crests of the first thread and has a constant pitch the same as that of the first thread.

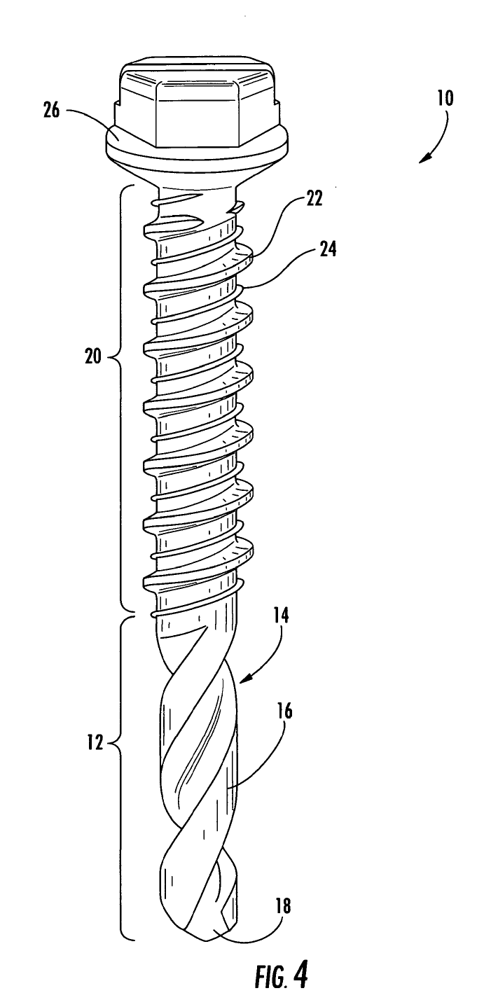

With reference to FIG. 4, a perspective view of an embodiment of the present invention is illustrated including a self-drilling and self-tapping concrete anchoring screw 10 having a threaded proximal portion 20 including a radially enlarged head 26 and a coaxial distal portion 12 including a concrete drill bit 14 having a fluted shank 16 between the concrete drill bit tip 18 and the beginning of the threaded proximal portion 20 of the concrete anchoring screw 10. The threaded proximal portion 20 will include a double lead, spaced thread configuration including a first thread helix 22 of a given height and a second helix 24 of a smaller height than the helix 22. This combination of elements permits the concrete anchoring screw 10 to drill into a concrete substrate owing to the ability of the fluted shank 16 to eject the particulates during the drilling operation thereby enabling the threaded proximal portion 20 to effectively thread its way into the concrete substrate. Spaces between thread helix 22 and adjacent second helix 24 serve as a reservoir to receive dust that is produced during the tapping operation. The screw 10 further includes a radially enlarged head 26, for driving the concrete anchoring screw 10 into the concrete substrate.

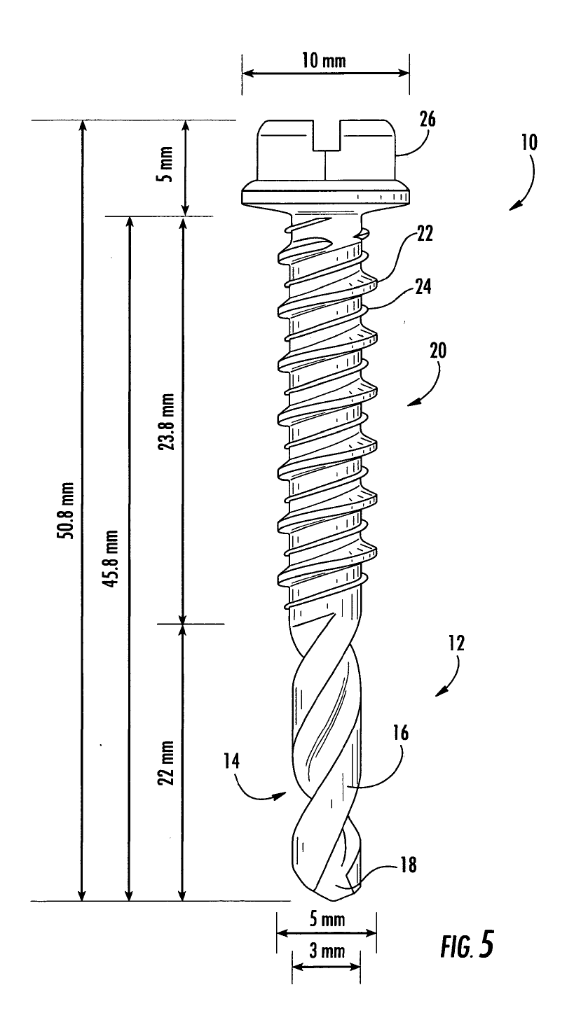

FIG. 5 illustrates the concrete anchoring screw of FIG. 4, which delineates the relative dimensions of an illustrative, albeit non-limiting embodiment. These illustrative dimensions include a total length of screw 10 of 50.8 mm; a threaded proximal portion 20 having a length of 23.8 mm and a maximum diameter of 5 mm, wherein the first thread helix 22 is 5 mm in diameter and second thread helix 24 has a diameter less than 5 mm; a fluted shank 16 having a length of 22 mm and a diameter of 5 mm; a total length of threaded proximal portion 20 and fluted shank 16 of 45.8 mm, and a radially enlarged head 26 of 10 mm.

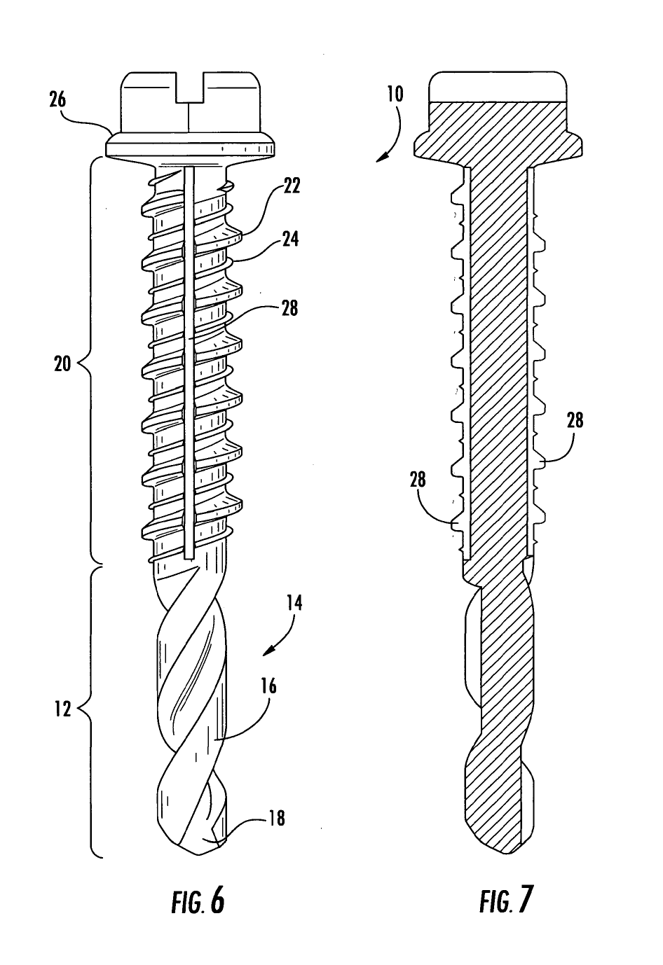

FIG. 6 illustrates a perspective view of a further embodiment of the present invention including a self-drilling and self-tapping concrete anchoring screw 10 having a threaded proximal portion 20 including a radially enlarged head 26 and a distal portion 12 including a concrete drill bit 14 having a fluted shank 16 between the concrete drill bit tip 18 and the beginning of the threaded proximal portion 20 of the concrete anchoring screw 10. The threaded proximal portion 20 will include a double lead, spaced thread configuration including a first thread helix 22 of a given height and a second helix 24 of a smaller height than the helix 22. This combination of elements permits the concrete anchoring screw 10 to drill into a concrete substrate owing to the ability of the fluted shank 16 to eject the particulates during the drilling operation thereby enabling the threaded proximal portion 20 to effectively thread its way into the concrete substrate. Spaces between thread helix 22 and adjacent second helix 24 serve as a reservoir to receive dust that is produced during the tapping operation. In this embodiment, the threaded proximal portion 20 further includes at least one relief slot 28, which is a longitudinal groove formed within the threaded proximal portion of said screw, traversing the first and second thread helix 22 and 24 for assisting in the ejection of debris. In the present embodiment, two relief slots 28 are illustrated, however the present invention contemplates the use of either one relief slot 28 or more than two relief slots 28. In situations where the thickness of the concrete substrate is greater than the length of the concrete anchoring screw 10, the one or more relief slots 28 provide a means for ejection of dust and debris from the hole during the combined drilling and tapping operation, thereby insuring a stable threaded attachment of high integrity.

FIG. 7 is a cross-sectional view of the embodiment of FIG. 6 taken through the relief slots 28.

The present invention teaches an improved self-drilling and self-tapping concrete anchoring screw, or SCREWCON. In an embodiment, the concrete anchoring screw may be manufactured by inserting steel wire into a computer numerical control (CNC) machine, where the wire is then cut into the screw head, the screw body and the fluted shank and concrete drill bit tip. This process will be carried out for each available size and length.

In an embodiment, the concrete anchoring screw may be a screw with a screw body diameter of 3/16″ and a screw body length of ¼″, ½″, ¾″, 1″, 1¼″, 1½″, 1¾″, 2″, 2¼″, 2½″, 2¾″, 3″, 3¼″, 3½″, 3¾″, 4″, 4¼″, 4½″, 4¾″, 5″, 5¼″, 5½″, 5¾″, and 6″, and is attached to a 5/32″ concrete drill bit tip.

In a further embodiment, the concrete anchoring screw is adapted to a screw with a screw body diameter of ¼″ and a screw body length of ¼″, ½″, ¾″, 1″, 1¼″, 1½″, 1¾″, 2″, 2¼″, 2½″, 2¾″, 3″, 3¼″, 3½″, 3¾″, 4″, 4¼″, 4½″, 4¾″, 5″, 5¼″, 5½″, 5¾″, and 6″, and is attached to a 3/16″ concrete drill bit tip.

In various embodiments, the concrete anchoring screw is adapted to a screw head size of ¼″, 5/16″, ⅜″, a hex head size of 3/16″, and an Allen head size of 3/16″.

The concrete anchoring screw is to be available in hardened steel, stainless steel and aluminum.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A self-drilling and self-tapping anchoring screw for attachment to a concrete substrate comprising:
a threaded proximal portion including a radially enlarged head and a coaxial distal portion, forming a concrete drill bit having a fluted shank and a concrete drill bit tip, said threaded proximal portion including a double lead, spaced thread configuration including a first thread helix of a given height and a second thread helix of a smaller height than said first thread helix; said first and second thread helix defining a space therebetween which serves as a reservoir to receive dust that is produced during the tapping operation;
whereby said fluted shank functions to eject any particulates created during a drilling operation thereby enabling the threaded proximal portion to form an effective threaded connection with the concrete substrate during said tapping operation.

2. The self drilling and self-tapping anchoring screw of claim 1, further including at least one longitudinal groove formed along the threaded proximal portion of said screw, traversing the first and second thread helix, whereby said at least one groove forms a relief slot to assist in the ejection of dust and particulates during the combined drilling and tapping operation.

3. The concrete anchoring screw recited in claim 1 wherein said anchoring screw is adapted to a screw with a screw body diameter of 3/16″ and a screw body length of ¼″, ½″, ¾″, 1″, 1¼″, 1½″, 1¾″, 2″, 2¼″, 2½″, 2¾″, 3″, 3¼″, 3½″, 3¾″, 4″, 4¼″, 4½″, 4¾″, 5″, 5¼″, 5½″, 5¾″, and 6″, and is attached to a 5/32″ concrete drill bit tip.

4. The concrete anchoring screw recited in claim 1 wherein said anchoring screw is adapted to a screw with a screw body diameter of ¼″ and a screw body length of ¼″, ½″, ¾″, 1″, 1¼″, 1½″, 1¾″, 2″, 2¼″, 2½″, 2¾″, 3″, 3¼″, 3½″, 3¾″, 4″, 4¼″, 4½″, 4¾″, 5″, 5¼″, 5½″, 5¾″, and 6″, and is attached to a 3/16″ concrete drill bit tip.

5. The concrete anchoring screw recited in claim 1, wherein said anchoring screw is adapted to a screw head size o ¼″, 5/16″, ⅜″, a hex head size of 3/16″, and an Allen head size of 3/16″.

6. The concrete anchoring screw recited in claim 1, wherein said anchoring screw is formed from hardened steel, stainless steel or aluminum.
